(19) United States
(12) Patent Application Publication
(10) Pub. No.: US 2026/0128755 A1
(43) Pub. Date: May 7, 2026

(54) DYNAMIC SWITCHING OF A RECEIVER OPERATING MODE

(71) Applicant: QUALCOMM Incorporated, San Diego, CA (US)

(72) Inventors: Saranyan NAGARAJAN, Hyderabad (IN); Raveesh JUNEJA, Hyderabad (IN); Arjun NADH, Hyderabad (IN); Tonmoy BISWAS, Bangalore (IN); Sree Venkatesh THATAVARTHY, Bangalore (IN)

(21) Appl. No.: 18/936,511

(22) Filed: Nov. 4, 2024

(51) Int. Cl. H04B 1/10; H04B 1/18

(52) U.S. Cl. CPC H04B 1/1081; H04B 1/18

(57) ABSTRACT

Certain aspects of the present disclosure generally relate to techniques and apparatus for dynamically switching an operating mode of a wireless receiver. An example method includes receiving signal(s) via a receive path including a first amplifier and a second amplifier having an input coupled to an output of the first amplifier. An operating mode of the receive path is dynamically switched to at least one of a first operating mode or a second operating mode while receiving the signal(s), based at least in part on a gain state of the second amplifier. In the first operating mode, receiving the signal(s) includes transferring a processed version of the signal(s) from the first amplifier to the second amplifier. In the second operating mode, receiving the signal(s) includes bypassing the first amplifier or setting a gain state of the first amplifier to a lowest gain value available for the first amplifier.

### TECHNICAL FIELD

Certain aspects of the present disclosure generally relate to electronic circuits and, more particularly, to techniques and apparatus for dynamically switching an operating mode of a wireless receiver.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), Zigbee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include one or more transmitters and receivers.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure provide a receiver. The receiver includes a receive path and control logic coupled to the receive path. The receive path includes a first amplifier and a second amplifier having an input coupled to an output of the first amplifier. The control logic is configured to dynamically switch an operating mode of the receive path to at least one of a first operating mode or a second operating mode based at least in part on a gain state of the receiver following the first amplifier. When receiving one or more signals in the first operating mode, the receive path is configured to transfer a processed version of the one or more signals from the first amplifier to the second amplifier. When receiving the one or more signals in the second operating mode, the receive path is configured to bypass the first amplifier or set a gain state of the first amplifier to a lowest gain value available for the first amplifier.

Certain aspects of the present disclosure provide a method of wireless communication. The method generally includes receiving one or more signals via a receiver comprising a receive path comprising a first amplifier and a second amplifier having an input coupled to an output of the first amplifier. The method also includes dynamically switching an operating mode of the receive path to at least one of a first operating mode or a second operating mode while receiving the one or more signals, based at least in part on a gain state of the receiver following the first amplifier. In the first operating mode, receiving the one or more signals includes transferring a processed version of the one or more signals from the first amplifier to the second amplifier. In the second operating mode, receiving the one or more signals includes bypassing the first amplifier or setting a gain state of the first amplifier to a lowest gain value available for the first amplifier.

Certain aspects of the present disclosure provide a wireless device. The wireless device includes an antenna and a receiver coupled to the antenna. The receiver includes a receive path and control logic coupled to the receive path. The receive path includes a first amplifier and a second amplifier having an input coupled to an output of the first amplifier. The control logic is configured to dynamically switch an operating mode of the receive path to at least one of a first operating mode or a second operating mode based at least in part on a gain state of the receiver following the first amplifier. When receiving one or more signals in the first operating mode, the receive path is configured to transfer a processed version of the one or more signals from the first amplifier to the second amplifier. When receiving the one or more signals in the second operating mode, the receive path is configured to bypass the first amplifier or set a gain state of the first amplifier to a lowest gain value available for the first amplifier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIGS. 4A and 4B illustrate example receiver configurations, in accordance with certain aspects of the present disclosure.

FIG. 5 illustrates an example receiver configuration for dynamically switching between operating modes, in accordance with certain aspects of the present disclosure.

FIG. 6 is a flow diagram illustrating example operations for wireless communication, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure generally relate to techniques and apparatus for dynamically switching an operating mode of a wireless receiver. In certain aspects, for example, a receiver may include a receive path (or receive chain) that includes at least a first amplifier and a second amplifier, and may be configured to switch between at least one of a first operating mode or a second operating mode for receiving wireless signals, based at least in part on a gain state of the second amplifier. When receiving signal(s) in the first operating mode, the receive path may be configured to transfer a processed version of the signal(s) from the first amplifier to the second amplifier. When receiving signal(s) in the second operating mode, the receive path may be configured to bypass the first amplifier or set a gain state of the first amplifier to a lowest gain value available for the first amplifier.

The techniques described herein can enable receivers to reduce power consumption and optimize (or at least improve) receive sensitivity without compromising throughput performance of downlink communications. For example, when the gain state of the second amplifier is set to certain overall system gain states of the receiver, the receiver may switch to the first operating mode to optimize (or at least improve) receive sensitivity, and when the gain state of the second amplifier is set to other overall system gain states of the receiver, the receiver may switch to the second operating mode to achieve optimal (or at least increased) power performance.

Additionally, in certain aspects, the techniques described herein can enable receivers to switch between different operating modes (e.g., to save power and preserve sensitivity) with a common matching network. Such a matching network, for example, may perform a broadband match at the input of the second amplifier (in the first operating mode) and may perform a narrowband match at the input of the second amplifier (in the second operating mode). As used herein, the overall gain state of a receiver may refer to the gain state of an amplifier (e.g., low noise amplifier (LNA)) within an RF front end portion of the receiver along with the gain state of an RF receiver portion of the receiver.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

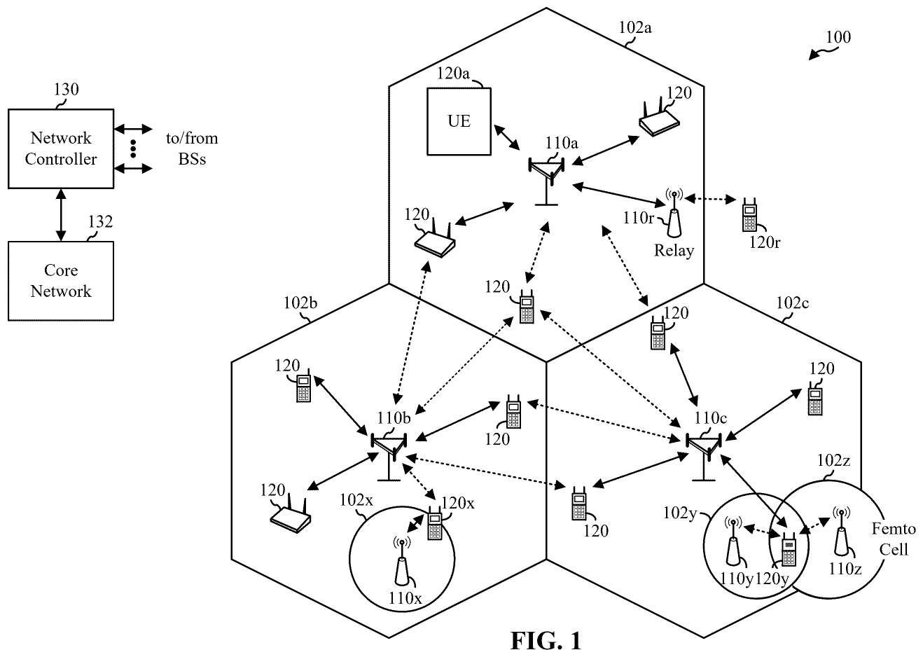

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may include a receiver configured to dynamically switch between different operating modes, as described in more detail herein.

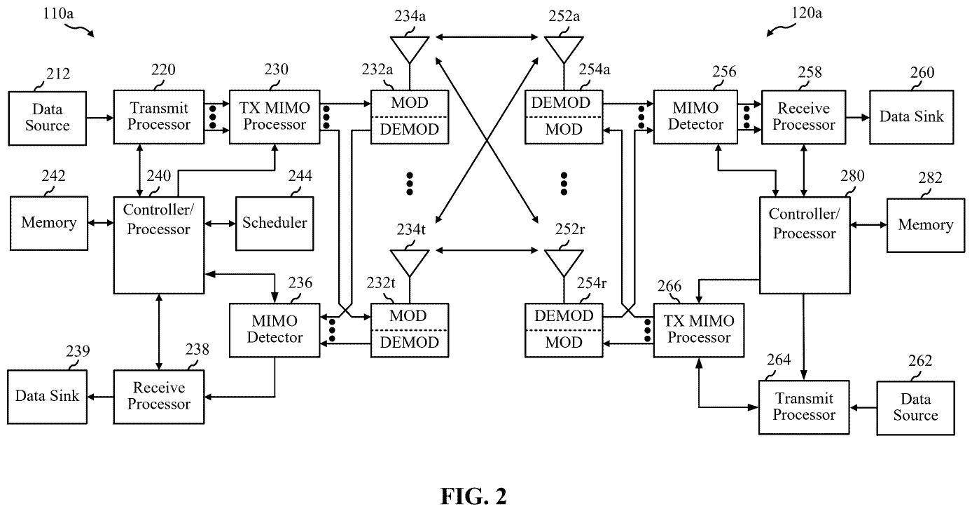

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In certain aspects of the present disclosure, the transceivers 232 and/or the transceivers 254 may be configured to dynamically switch between different operating modes when receiving signal(s), as described in more detail herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

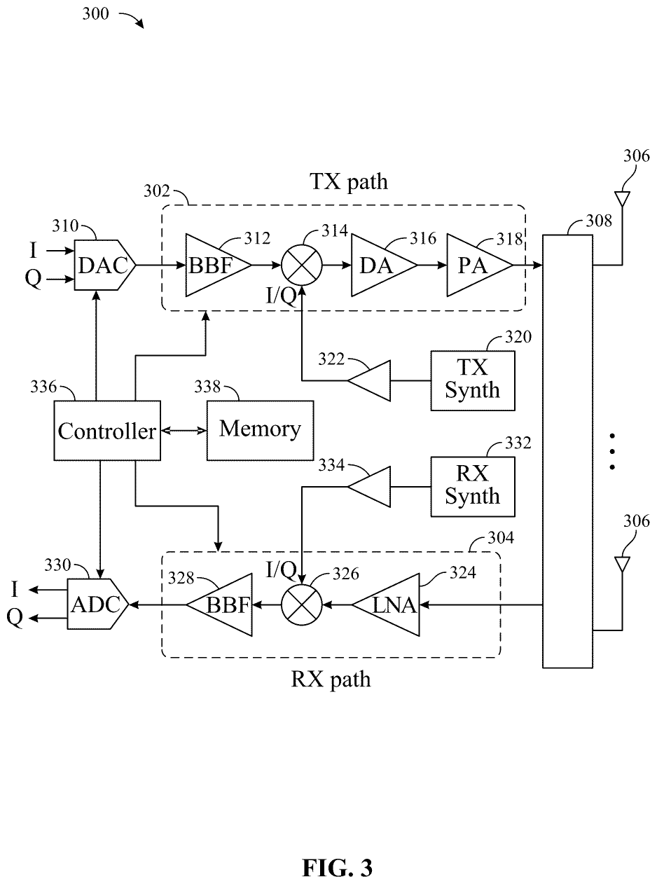

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing. In certain aspects, the RX path 304 may be dynamically switched to different operating modes for receiving wireless signals, as described in more detail herein.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency multiplier, such as a frequency doubler, that is driven by an oscillator (e.g., a VCO) in the frequency synthesizer.

A controller 336 (e.g., controller/processor 280 in FIG. 2) may direct the operation of the RF transceiver circuit 300, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example Dynamic Switching of a Receiver Operating Mode

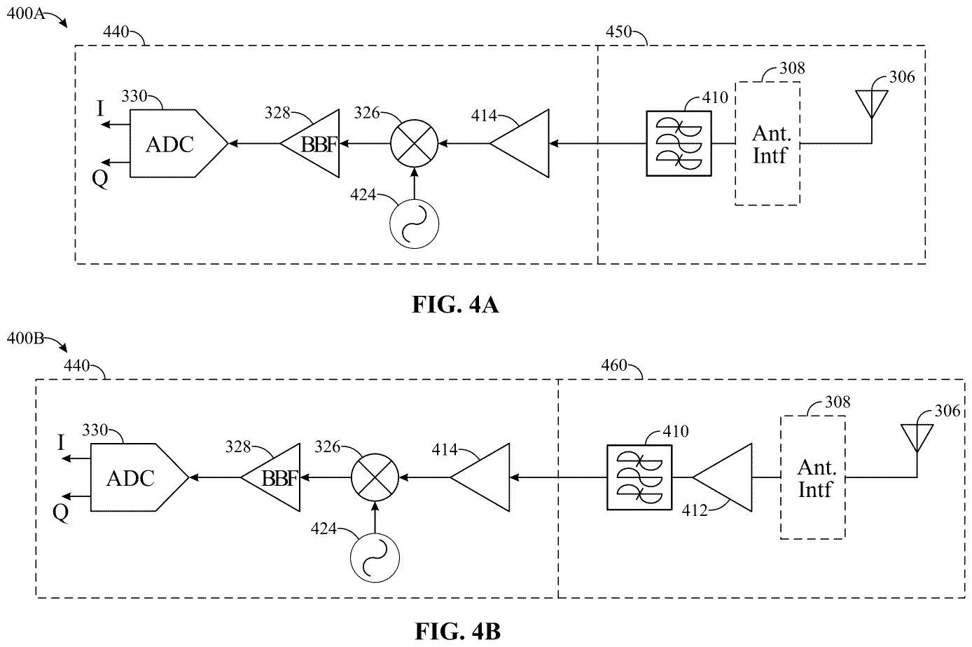

One challenge with conventional receiver designs is that there is typically a tradeoff between achieving improved power consumption performance and achieving improved receive sensitivity performance. For example, certain receiver configurations may allow a receiver to achieve improved power performance (e.g., reduced power consumption during receive operation) and certain other receiver configurations may allow a receiver to achieve improved sensitivity. By way of example, consider FIGS. 4A and 4B, which depict different example receiver configurations 400A and 400B (or lineups), respectively, according to certain aspects of the present disclosure.

As shown in FIG. 4A, the receiver configuration 400A includes, without limitation, an RF receiver portion 440 and an RF front end portion 450. The RF front end portion 450 includes, without limitation, an antenna 306, an (antenna) interface 308, and a bandpass filter 410. The RF receiver portion 440 includes, without limitation, an amplifier 414 (e.g., LNA 324), a mixer 326, a BBF 328, and an ADC 330. In certain aspects, the RF receiver portion 440 may be an illustrative example of at least a portion of RX path 304 of RF transceiver circuit 300.

In receive operation for the receiver configuration 400A, RF signals received via the antenna(s) 306 may pass through the interface 308, which may include any of various suitable RF devices, such as a switch, duplexer, diplexer, and multiplexer, as illustrative examples. RF signals output from the interface 308 may be filtered via bandpass filter 410. The amplifier 414 amplifies the filtered RF signals output from the bandpass filter 410. The mixer 326 mixes the amplified RF signals with the receiver (RX) local oscillator (LO) signal 424 to convert the RF signal of interest to a different baseband frequency (e.g., downconvert). The baseband signals output by the mixer 326 may be filtered by the BBF 328 before being converted by the ADC 330 to digital I and/or Q signals for digital signal processing.

As shown in FIG. 4B, the receiver configuration 400B includes, without limitation, the RF receiver portion 440 and an RF front end portion 460. Compared to the RF front end portion 450 of receiver configuration 400A, the RF front end portion 460 includes an amplifier 412 (e.g., LNA) coupled between the interface 308 and the bandpass filter 410. For example, in receive operation for the receiver configuration 400B, RF signals received via the antenna(s) 306 may pass through the interface 308. RF signals output from the interface 308 may be amplified via amplifier 412 before being filtered via bandpass filter 410. The RF receiver portion 440 may then process the filtered RF signals output from the RF front end portion 460, as described herein.

In certain cases, the receiver configuration 400A may allow a receiver to achieve improved power performance (e.g., reduced power consumption during receive operation), and the receiver configuration 400B may allow a receiver to achieve improved sensitivity.

Certain aspects of the present disclosure provide techniques for dynamically switching an operating mode of a wireless receiver. In certain aspects, the receiver may be configured to operate according to a first operating mode or a second operating mode, based in part on the gain state of the receiver (e.g., receiver configuration 500) within the RF receiver portion of the wireless receiver.

For example, in certain aspects, a receiver may be configured to use the receiver configuration 400B (e.g., first operating mode) when the gain state of the receiver configuration 400B is set to certain higher overall system gain states of the receiver, such as a G0 gain state and G1 gain state, as illustrative examples. Additionally, the receiver may be configured to use the receiver configuration 400A (e.g., second operating mode) when the gain state of the receiver configuration 400A is set to certain lower overall system gain states of the receiver, such as a G2 gain state and beyond (where G0>G1>G2. . . GN). By dynamically switching the operating mode of the receiver in this manner, certain aspects described herein may enable a receiver to achieve improved sensitivity (e.g., for higher overall system gain states of the receiver) and achieve improved power consumption performance (e.g., for lower overall system gain states of the receiver) without compromising the throughput performance at certain downlink levels.

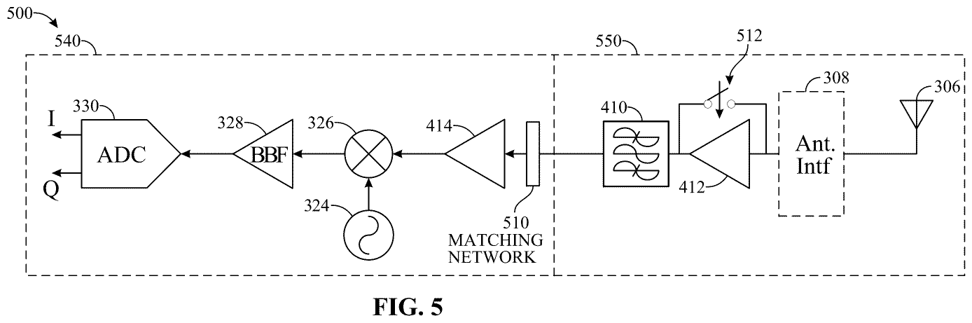

Consider FIG. 5, which depicts an example receiver configuration 500 that allows for dynamically switching an operating mode of the receiver, according to certain aspects of the present disclosure. Here, the receiver configuration 500 includes, without limitation, a RF receiver portion 540 and an RF front end portion 550. Compared to the RF receiver portion 440 of receiver configurations 400A and 400B, the RF receiver portion 540 includes a matching network 510 coupled to the input of the amplifier 414. In certain aspects, compared to the RF front end portions 450 and 460 of receiver configurations 400A and 400B, respectively, the RF front end portion 550 includes a switch 512 coupled between the input and output of the amplifier 412.

Note, in certain aspects, the matching network 510 may be a part of RF receiver portion 540 in certain configurations of receiver configuration 500. In other aspects, the matching network 510 may be a part of RF front end portion 550 in certain other configurations of receiver configuration 500.

In certain aspects, the receiver configuration 500 may be configured to operate similar to the receiver configuration 400B (e.g., first operating mode) or receiver configuration 400A (e.g., second operating mode), based on the overall gain state of the receiver configuration 500. For example, when the gain state of the receiver configuration 500 is set to an overall system gain state of G0 or G1, the receiver configuration 500 may be configured to operate similar to the receiver configuration 400B. For instance, when the gain state of the receiver configuration 500 is G0 or G1, the switch 512 may be in an open state, such that the amplifier 414 receives a processed (e.g., amplified) version of RF signals from the RF front end portion 550. On the other hand, when the gain state of the receiver configuration 500 is set to an overall system gain state of G2, G3, or beyond, the receiver configuration 500 may be configured to operate similar to the receiver configuration 400A. For instance, when the gain state of the receiver configuration 500 is G2, G3, or beyond, the switch 512 may be in a closed state, such that RF signals received via the antenna 306 bypass the amplifier 412.

The switch 512 may be implemented by a transmission gate or any of other various suitable components, such as a field-effect transistor (FET) (with a p-type metal-oxide-semiconductor (PMOS) implementation or an n-type metal-oxide-semiconductor (NMOS) implementation), negative-positive-negative (NPN) transistor, or positive-negative-positive (PNP) transistor, as illustrative, non-limiting examples. In certain cases, the switch 512 may be configured to be in a closed state or open state in response to receiving a control signal from a controller, such as controller 336.

In certain aspects, the matching network 510 may implement a common match at the input of the amplifier 414 notwithstanding whether the receiver configuration 500 is operating similar to the receiver configuration 400B (e.g., first operating mode) or the receiver configuration 400A (e.g., second operating mode). As noted, when the receiver configuration 500 is operating similar to the receiver configuration 400B, the matching network 510 may perform a broadband match, and when the receiver configuration 500 is operating similar to the receiver configuration 400A, the matching network 510 may perform a narrowband match. In certain aspects, the matching network 510 may include at least one of a shunt capacitive element, a shunt inductive element, a pi network, or a T network.

Note FIG. 5 depicts an illustrative example of a receiver configuration that is able to dynamically switch between different operating modes, and that other receiver configurations consistent with the functionality described herein are contemplated. For example, while the receiver configuration 500 depicts a switch 512 coupled between the input and output of the amplifier 412, in certain aspects, a receiver configuration may be configured to dynamically switch between different operation modes without the switch 512. In such aspects, the receiver configuration may set a gain state of the amplifier 412 to a lowest gain value available for the amplifier 412 in order to operate similar to the receiver configuration 400A (e.g., second operating mode), and the receiver configuration may set the gain state of the amplifier 412 to a higher gain value available for the amplifier 412 in order to operate similar to the receiver configuration 400B (e.g., first operating mode). For example, in such aspects, when the gain state of the amplifier 412 is set to a lowest gain value available for the amplifier 412, the amplifier 412 may have zero (or at least a negligible) effect on RF signals that are input to the amplifier 412, such that the amplifier 412 is effectively bypassed.

### Example Operations

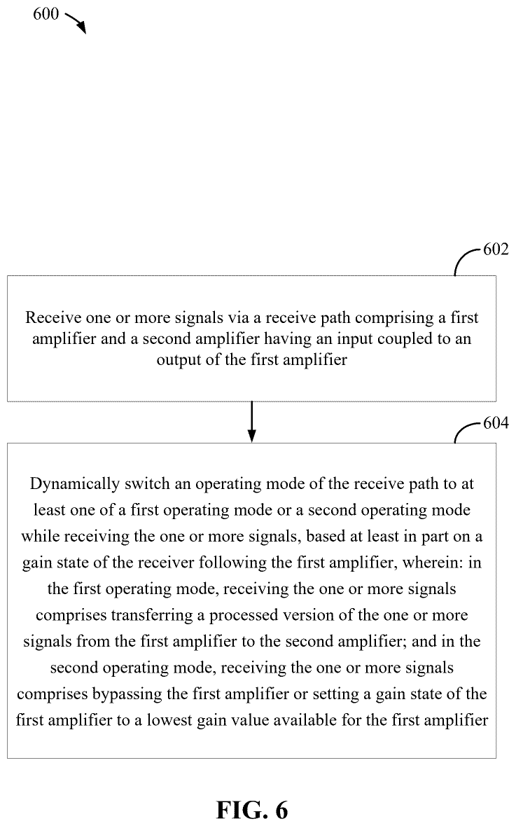

FIG. 6 is a flow diagram illustrating example operations 600 for wireless communication, in accordance with certain aspects of the present disclosure. The operations 600 may be performed, for example, by a receiver, such as a receiver with receiver configuration 500.

At block 602, the receiver may receive one or more signals via a receive path including a first amplifier (e.g., amplifier 412) and a second amplifier (e.g., amplifier 414) having an input coupled to an output of the first amplifier.

At block 604, the receiver may dynamically switch an operating mode of the receive path to at least one of a first operating mode (e.g., receiver configuration 400B) or a second operating mode (e.g., receiver configuration 400A) while receiving the one or more signals, based at least in part on a gain state of the receiver following the first amplifier. In the first operating mode, receiving the one or more signals may include transferring a processed version of the one or more signals from the first amplifier to the second amplifier. In the second operating mode, receiving the one or more signals may include bypassing the first amplifier or setting a gain state of the first amplifier to a lowest gain value available for the first amplifier.

In certain aspects, dynamically switching the operating mode may be further based at least in part on a presence of a jammer signal. For example, the operating mode may be switched to the first operating mode to improve the signal-to-noise ratio (SNR) in the presence of an external jammer that degrades the SNR/throughput performance. On the other hand, the operating mode may be switched to the second operating mode in the absence of an external jammer.

In certain aspects, dynamically switching the operating mode may include switching the operating mode to the first operating mode when the gain state of the receiver is set to one of a first gain state (e.g., G0) and a second gain state (e.g., G1) of the first set of gain states associated with an overall gain state of the receiver. In some examples, the one of the first gain state and the second gain state of the first set of gain states may have a highest gain value out of the first set of gain states.

In certain aspects, dynamically switching the operating mode may include switching the operating mode to the second operating mode when the gain state is set to one of a second set of gain states associated with the overall gain state of the receiver. In some examples, dynamically switching the operating mode to the second operating mode may include setting the gain state of the first amplifier to the lowest gain value available for the first amplifier. In some examples, dynamically switching the operating mode to the second operating mode may include configuring a switch (e.g., switch 512) coupled between an input of the first amplifier and the output of the first amplifier in a closed state.

In certain aspects, each gain value associated with the first set of gain states of the overall gain state may be higher than each gain value associated with the second set of gain states of the overall gain state.

In certain aspects, receiving the one or more signals may include (i) in the first operating mode, transferring the processed version of the one or more signals from the first amplifier to the second amplifier via a matching network, and (ii) in the second operating mode, receiving the one or more signals at the input of the second amplifier via the matching network with the gain state of the first amplifier set to the lowest gain value available for the first amplifier. The matching network may include at least one of a shunt capacitive element, a shunt inductive element, a pi network, or a T network.

### Example Aspects

In addition to the various aspects described above, specific combinations of aspects are within the scope of the present disclosure, some of which are detailed below:

Aspect 1: A receiver comprising: a receive path comprising a first amplifier and a second amplifier having an input coupled to an output of the first amplifier; and control logic coupled to the receive path and configured to dynamically switch an operating mode of the receive path to at least one of a first operating mode or a second operating mode based at least in part on a gain state of the receiver following the first amplifier, wherein: when receiving one or more signals in the first operating mode, the receive path is configured to transfer a processed version of the one or more signals from the first amplifier to the second amplifier; and when receiving the one or more signals in the second operating mode, the receive path is configured to bypass the first amplifier or set a gain state of the first amplifier to a lowest gain value available for the first amplifier.

Aspect 2: The receiver of Aspect 1, wherein the control logic is configured to dynamically switch the operating mode to the first operating mode when the gain state is set to one of a first gain state and a second gain state of the first set of gain states associated with an overall gain state of the receiver.

Aspect 3: The receiver of Aspect 2, wherein the one of the first gain state and the second gain state of the first set of gain states has a highest gain value out of the first set of gain states.

Aspect 4: The receiver according to any of Aspects 2-3, wherein the control logic is configured to dynamically switch the operating mode to the second operating mode when the gain state is set to one of a second set of gain states associated with the overall gain state of the receiver.

Aspect 5: The receiver of Aspect 4, wherein to dynamically switch the operating mode to the second operating mode, the control logic is configured to set the gain state of the first amplifier to the lowest gain value available for the first amplifier.

Aspect 6: The receiver of Aspect 4, wherein: the receive path further comprises a switch coupled between an input of the first amplifier and the output of the first amplifier; and to dynamically switch the operating mode to the second operating mode, the control logic is configured to configure the switch in a closed state.

Aspect 7: The receiver according to any of Aspects 4-6, wherein each gain value associated with the first set of gain states of the overall gain state is higher than each gain value associated with the second set of gain states of the overall gain state

Aspect 8: The receiver according to any of Aspects 1-7, wherein: the receive path further comprises a matching network coupled between the first amplifier and the second amplifier; in the first operating mode, the receive path is configured to transfer the processed version of the one or more signals from the first amplifier to the second amplifier via the matching network; and in the second operating mode, the receive path is configured to receive the one or more signals at the input of the second amplifier via the matching network with the gain state of the first amplifier set to the lowest gain value available for the first amplifier.

Aspect 9: The receiver of Aspect 8, wherein the matching network comprises at least one of a shunt capacitive element, a shunt inductive element, a pi network, or a T network.

Aspect 10: The receiver according to any of Aspects 1-9, wherein the control logic is configured to dynamically switch the operating mode of the receive path further based at least in part on a presence of a jammer signal.

Aspect 11: A method of wireless communication, comprising: receiving one or more signals via a receiver comprising a receive path comprising a first amplifier and a second amplifier having an input coupled to an output of the first amplifier; and dynamically switching an operating mode of the receive path to at least one of a first operating mode or a second operating mode while receiving the one or more signals, based at least in part on a gain state of the receiver following the first amplifier, wherein: in the first operating mode, receiving the one or more signals comprises transferring a processed version of the one or more signals from the first amplifier to the second amplifier; and in the second operating mode, receiving the one or more signals comprises bypassing the first amplifier or setting a gain state of the first amplifier to a lowest gain value available for the first amplifier.

Aspect 12: The method of Aspect 11, wherein dynamically switching the operating mode comprises switching the operating mode to the first operating mode when the gain state is set to one of a first gain state and a second gain state of the first set of gain states associated with an overall gain state of the receiver.

Aspect 13: The method of Aspect 12, wherein the one of the first gain state and the second gain state of the first set of gain states has a highest gain value out of the first set of gain states.

Aspect 14: The method according to any of Aspects 12-13, wherein dynamically switching the operating mode comprises switching the operating mode to the second operating mode when the gain state is set to one of a second set of gain states associated with the overall gain state of the receiver.

Aspect 15: The method of Aspect 14, wherein dynamically switching the operating mode to the second operating mode comprises setting the gain state of the first amplifier to the lowest gain value available for the first amplifier.

Aspect 16: The method of Aspect 14, wherein: the receive path further comprises a switch coupled between an input of the first amplifier and the output of the first amplifier; and switching the operating mode to the second operating mode comprises configuring the switch in a closed state.

Aspect 17: The method according to any of Aspects 14-16, wherein each gain value associated with the first set of gain states of the overall gain state is higher than each gain value associated with the second set of gain states of the overall gain state.

Aspect 18: The method according to any of Aspects 11-17, wherein receiving the one or more signals comprises: in the first operating mode, transferring the processed version of the one or more signals from the first amplifier to the second amplifier via a matching network; and in the second operating mode, receiving the one or more signals at the input of the second amplifier via the matching network with the gain state of the first amplifier set to the lowest gain value available for the first amplifier.

Aspect 19: The method of Aspect 18, wherein the matching network comprises at least one of a shunt capacitive element, a shunt inductive element, a pi network, or a T network.

Aspect 20: A wireless device comprising: an antenna; and a receiver coupled to the antenna, the receiver comprising: a receive path comprising a first amplifier and a second amplifier having an input coupled to an output of the first amplifier; and control logic coupled to the receive path and configured to dynamically switch an operating mode of the receive path to at least one of a first operating mode or a second operating mode based at least in part on a gain state of the receiver following the first amplifier, wherein: when receiving one or more signals in the first operating mode, the receive path is configured to transfer a processed version of the one or more signals from the first amplifier to the second amplifier; and when receiving the one or more signals in the second operating mode, the receive path is configured to bypass the first amplifier or set a gain state of the first amplifier to a lowest gain value available for the first amplifier.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components. For example, means for receiving may include an antenna, such as the antenna 306 of FIG. 3, an RF front end, such as the RF front end portion 550 of FIG. 5, and/or an RF receiver, such as the RF receiver portion 540 of FIG. 5. Means for dynamically switching an operating mode of the receive path may include a controller (or processor), such as the controller 336 of FIG. 3. Means for transferring a processed version of the one or more signals may include an amplifier, such as the amplifier 412 of FIG. 5, an RF front end, such as the RF front end portion 550 of FIG. 5, an RF receiver, such as the RF receiver portion 540 of FIG. 5, and/or a matching network, such as the matching network 510 of FIG. 5. Means for bypassing the first amplifier may include a switch, such as the switch 512 of FIG. 5. Means for setting a gain state of the first amplifier may include a controller (or processor), such as the controller 336 of FIG. 3. Means for controlling a switch may include a controller (or processor), such as the controller 336 of FIG. 3.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A receiver comprising:
a receive path comprising a first amplifier and a second amplifier having an input coupled to an output of the first amplifier; and
control logic coupled to the receive path and configured to dynamically switch an operating mode of the receive path to at least one of a first operating mode or a second operating mode based at least in part on a gain state of the receiver following the first amplifier, wherein:
when receiving one or more signals in the first operating mode, the receive path is configured to transfer a processed version of the one or more signals from the first amplifier to the second amplifier; and
when receiving the one or more signals in the second operating mode, the receive path is configured to bypass the first amplifier or set a gain state of the first amplifier to a lowest gain value available for the first amplifier.

2. The receiver of claim 1, wherein the control logic is configured to dynamically switch the operating mode to the first operating mode when the gain state is set to one of a first gain state and a second gain state of the first set of gain states associated with an overall gain state of the receiver.

3. The receiver of claim 2, wherein the one of the first gain state and the second gain state of the first set of gain states has a highest gain value out of the first set of gain states.

4. The receiver of claim 2, wherein the control logic is configured to dynamically switch the operating mode to the second operating mode when the gain state is set to one of a second set of gain states associated with the overall gain state of the receiver.

5. The receiver of claim 4, wherein to dynamically switch the operating mode to the second operating mode, the control logic is configured to set the gain state of the first amplifier to the lowest gain value available for the first amplifier.

6. The receiver of claim 4, wherein:
the receive path further comprises a switch coupled between an input of the first amplifier and the output of the first amplifier; and
to dynamically switch the operating mode to the second operating mode, the control logic is configured to configure the switch in a closed state.

7. The receiver of claim 4, wherein each gain value associated with the first set of gain states of the overall gain state is higher than each gain value associated with the second set of gain states of the overall gain state.

8. The receiver of claim 1, wherein:
the receive path further comprises a matching network coupled between the first amplifier and the second amplifier;
in the first operating mode, the receive path is configured to transfer the processed version of the one or more signals from the first amplifier to the second amplifier via the matching network; and
in the second operating mode, the receive path is configured to receive the one or more signals at the input of the second amplifier via the matching network with the gain state of the first amplifier set to the lowest gain value available for the first amplifier.

9. The receiver of claim 8, wherein the matching network comprises at least one of a shunt capacitive element, a shunt inductive element, a pi network, or a T network.

10. The receiver of claim 1, wherein the control logic is configured to dynamically switch the operating mode of the receive path further based at least in part on a presence of a jammer signal.

11. A method of wireless communication, comprising:
receiving one or more signals via a receiver comprising a receive path comprising a first amplifier and a second amplifier having an input coupled to an output of the first amplifier; and
dynamically switching an operating mode of the receive path to at least one of a first operating mode or a second operating mode while receiving the one or more signals, based at least in part on a gain state of the receiver following the first amplifier, wherein:
in the first operating mode, receiving the one or more signals comprises transferring a processed version of the one or more signals from the first amplifier to the second amplifier; and
in the second operating mode, receiving the one or more signals comprises bypassing the first amplifier or setting a gain state of the first amplifier to a lowest gain value available for the first amplifier.

12. The method of claim 11, wherein dynamically switching the operating mode comprises switching the operating mode to the first operating mode when the gain state is set to one of a first gain state and a second gain state of the first set of gain states associated with an overall gain state of the receiver.

13. The method of claim 12, wherein the one of the first gain state and the second gain state of the first set of gain states has a highest gain value out of the first set of gain states.

14. The method of claim 12, wherein dynamically switching the operating mode comprises switching the operating mode to the second operating mode when the gain state is set to one of a second set of gain states associated with the overall gain state of the receiver.

15. The method of claim 14, wherein dynamically switching the operating mode to the second operating mode comprises setting the gain state of the first amplifier to the lowest gain value available for the first amplifier.

16. The method of claim 14, wherein:
the receive path further comprises a switch coupled between an input of the first amplifier and the output of the first amplifier; and
dynamically switching the operating mode to the second operating mode comprises configuring the switch in a closed state.

17. The method of claim 14, wherein each gain value associated with the first set of gain states of the overall gain state is higher than each gain value associated with the second set of gain states of the overall gain state.

18. The method of claim 11, wherein receiving the one or more signals comprises:
in the first operating mode, transferring the processed version of the one or more signals from the first amplifier to the second amplifier via a matching network; and
in the second operating mode, receiving the one or more signals at the input of the second amplifier via the matching network with the gain state of the first amplifier set to the lowest gain value available for the first amplifier.

19. The method of claim 18, wherein the matching network comprises at least one of a shunt capacitive element, a shunt inductive element, a pi network, or a T network.

20. A wireless device comprising:
an antenna; and
a receiver coupled to the antenna, the receiver comprising:
a receive path comprising a first amplifier and a second amplifier having an input coupled to an output of the first amplifier; and
control logic coupled to the receive path and configured to dynamically switch an operating mode of the receive path to at least one of a first operating mode or a second operating mode based at least in part on a gain state of the receiver following the first amplifier, wherein:
when receiving one or more signals in the first operating mode, the receive path is configured to transfer a processed version of the one or more signals from the first amplifier to the second amplifier; and
when receiving the one or more signals in the second operating mode, the receive path is configured to bypass the first amplifier or set a gain state of the first amplifier to a lowest gain value available for the first amplifier.
